(19) United States
(12) Patent Application Publication
(10) Pub. No.: US 2025/0304770 A1
(43) Pub. Date: Oct. 2, 2025

(54) ANTISTATIC AND FLAME-RETARDANT RUTILE TITANIUM DIOXIDE-LOADED ANTIMONY TIN OXIDE (ATO)/EXPANDED POLYSTYRENE (EPS) COMPOSITE, AND PREPARATION METHOD AND USE THEREOF

(71) Applicants: Liaoning Litian New Material Co., Ltd, Huludao City (CN); Jiangsu Univeristy, Zhenjiang City (CN)

(72) Inventors: Yingchun YUAN, Huludao City (CN); Aili WANG, Huludao City (CN); Kai WANG, Huludao City (CN); Jinliang HAN, Huludao City (CN); Minshan LU, Huludao City (CN); Hengbo YIN, Huludao City (CN); Xiangyang ZHU, Huludao City (CN); Meng WANG, Huludao City (CN); Xin MAN, Huludao City (CN); Peng LI, Huludao City (CN)

(21) Appl. No.: 18/823,939

(22) Filed: Sep. 4, 2024

(30) Foreign Application Priority Data
Apr. 1, 2024 (CN) 202410389421.1

(51) Int. Cl. C08K 9/06; C08J 9/00; C08J 9/12; C09K 21/02

(52) U.S. Cl. CPC C08K 9/06; C08J 9/009; C08J 9/122; C09K 21/02; C08J 2203/06; C08J 2325/06; C08K 2201/001

(57) ABSTRACT

Provided are an antistatic and flame-retardant rutile titanium dioxide (TiO₂)-loaded antimony tin oxide (ATO)/expanded polystyrene (EPS) composite, and a preparation method and use thereof. The antistatic and flame-retardant rutile TiO₂-loaded ATO (TiO₂@ATO)/EPS composite includes EPS and rutile TiO₂@ATO doped in the EPS; where the antistatic and flame-retardant rutile TiO₂@ATO/EPS composite is doped with 0.5 wt. % to 2 wt. % of the rutile TiO₂@ATO based on a mass of a styrene monomer.

### CROSS REFERENCE TO RELATED APPLICATION

This patent application claims the benefit and priority of Chinese Patent Application No. 2024103894211 filed with the China National Intellectual Property Administration on Apr. 1, 2024, the disclosure of which is incorporated by reference herein in its entirety as part of the present application.

### TECHNICAL FIELD

The present disclosure relates to the technical field of EPS composites, in particular relates to an antistatic and flame-retardant rutile titanium dioxide (TiO₂)-loaded antimony tin oxide (ATO)/expanded polystyrene (EPS) composite, and a preparation method and use thereof.

### BACKGROUND

Expanded polystyrene (EPS) refers to granules containing a foaming agent in a polystyrene matrix. Due to excellent properties such as low thermal conductivity and water absorption, sound insulation, moisture resistance, shock resistance, strong impact resistance, and simple molding process, the EPS is widely used as a heat insulation, smoke proof, and earthquake-resistant material in the fields of construction, shipbuilding, automobile, train, refrigeration and other industries. Further, the EPS is also widely used as a packaging material and has extremely broad application prospects.

Due to the trend of global economy transitioning to clean energy, a demand for EPS with single function is becoming increasingly saturated, while a demand for functional EPS is increasing, such as antistatic EPS, flame-retardant EPS, super-hydrophobic EPS, antibacterial EPS, colored EPS, and toughened EPS. In the foreseeable future, the functional EPS may become increasingly important in the material industry.

Traditional antistatic polystyrene composites generally improve conductivity by doping with conductive organic substances such as carbon black, carbon fiber, and polyaniline. These doping methods have complex manufacturing processes, high costs, large environmental pollutions, and high waste disposal costs. Moreover, due to the doping with flammable organic substances, the antistatic performance is improved but the flame-retardant safety is further reduced, making it impossible to take into account both antistatic effect and flame retardancy.

### SUMMARY

In view of this, an object of the present disclosure is to provide an antistatic and flame-retardant rutile TiO₂-loaded antimony tin oxide (ATO)/expanded polystyrene (EPS) composite (“/” refers to “and”), and a preparation method and use thereof. In the present disclosure, the antistatic and flame-retardant rutile TiO₂-loaded ATO (TiO₂@ATO)/EPS composite has both antistatic effect and flame retardancy.

To achieve the above object, the present disclosure provides the following technical solutions:

The present disclosure provides an antistatic and flame-retardant rutile TiO₂@ATO/EPS composite, including EPS and rutile TiO₂@ATO doped in the EPS; where the antistatic and flame-retardant rutile TiO₂@ATO/EPS composite is doped with 0.5 wt. % to 2 wt. % of the rutile TiO₂@ATO based on a mass of a styrene monomer.

In some embodiments, the rutile TiO₂@ATO is doped at 1 wt. % to 1.5 wt. %.

In some embodiments, a tin element has a mass percentage of 20% and an antimony element has a mass percentage of 3% to 8% in the rutile TiO₂@ATO.

In some embodiments, the antimony element has a mass percentage of 5% in the rutile TiO₂@ATO.

The present disclosure further provides a method for preparing the antistatic and flame-retardant rutile TiO₂@ATO/EPS composite as mentioned above, including the following steps:
mixing the rutile TiO₂@ATO, a silane coupling agent, and an organic solvent, and conducting modification to obtain a modified rutile TiO₂@ATO;
mixing the modified rutile TiO₂@ATO, the styrene monomer, an initiator, a dispersant, an auxiliary dispersant, and water, and subjecting a resulting mixture to polymerization to obtain rutile TiO₂@ATO-doped polystyrene particles; and
subjecting the rutile TiO₂@ATO-doped polystyrene particles to foaming to obtain the antistatic and flame-retardant rutile TiO₂@ATO/EPS composite.

In some embodiments, a mass ratio of the rutile TiO₂@ATO to the silane coupling agent is in a range of 1:(0.05-0.15).

In some embodiments, a mass ratio of the modified rutile TiO₂@ATO, the styrene monomer, the initiator, the dispersant, and the auxiliary dispersant is in a range of (0.1-0.4):20:0.5:(0.14-0.35):(0.303-0.7575).

In some embodiments, the initiator includes dibenzoyl peroxide (BPO, CAS: 94-36-0);
the dispersant includes hydroxyapatite; and
the auxiliary dispersant includes sodium dodecylbenzene sulfonate (SDBS) and anhydrous sodium carbonate, with a mass ratio of the SDBS to the anhydrous sodium carbonate being in a range of (0.01-0.025):(1-2.5).

In some embodiments, the foaming is conducted at a temperature of 90° C. to 110° C. for 6 h to 12 h.

The present disclosure further provides use of the antistatic and flame-retardant rutile TiO₂@ATO/EPS composite as mentioned above or the antistatic and flame-retardant rutile TiO₂@ATO/EPS composite prepared by the method as mentioned above in an antistatic and flame-retardant thermal insulation material and a building thermal insulation material.

The present disclosure provides an antistatic and flame-retardant rutile TiO₂@ATO/EPS composite, including EPS and rutile TiO₂-loaded ATO (rutile TiO₂@ATO) doped in the EPS; where the antistatic and flame-retardant rutile TiO₂@ATO/EPS composite is doped with 0.5 wt. % to 2 wt. % of the rutile TiO₂@ATO based on a mass of a styrene monomer.

Compared with the prior art, some embodiments of the present disclosure have the following beneficial effects:

Rutile TiO₂@ATO is used as a dopant to give EPS unique properties, such that the EPS composite has antistatic and flame-retardant properties. On the basis of taking into account the antistatic and flame-retardant functions, the rutile TiO₂@ATO is different from the traditional method of organic matter doping, with less environmental pollution, lower raw material prices, simpler process, and lower doping amount than the traditional method of organic matter doping. This further reduces the production cost and the difficulty of handling reaction waste.

The data of examples show that when the addition amount of rutile TiO₂@ATO is 0.5% to 2% (calculated by the mass of styrene monomer), the prepared antistatic and flame-retardant rutile TiO₂@ATO/EPS composite has a surface resistance of 3.3×10⁸ kΩ to 5.2×10⁴ kΩ and a limiting oxygen index of 25.5% to 35.7%.

The present disclosure further provides a method for preparing the antistatic and flame-retardant rutile TiO₂@ATO/EPS composite as mentioned above. The method has simple process, low equipment requirements, low raw material price, low reaction waste treatment cost, and low environmental pollution.

### BRIEF DESCRIPTION OF THE DRAWINGS

FIG. 1 shows a scanning electron microscopy (SEM) image of the rutile TiO₂@ATO prepared in Example 1;

FIG. 2 shows a physical picture of the rutile TiO₂@ATO/EPS composite doped with 0.5 wt. % of the rutile TiO₂@ATO prepared in Example 3;

FIG. 3 shows a physical picture of the rutile TiO₂@ATO/EPS composite doped with 1 wt. % of the rutile TiO₂@ATO prepared in Example 6; and

FIG. 4 shows a physical picture of the rutile TiO₂@ATO/EPS composite doped with 2 wt. % of the rutile TiO₂@ATO prepared in Example 8.

### DETAILED DESCRIPTION OF THE EMBODIMENTS

The present disclosure provides an antistatic and flame-retardant rutile TiO₂@ATO/EPS composite, including EPS and rutile TiO₂@ATO doped (by physical doping) in the EPS; where the antistatic and flame-retardant rutile TiO₂@ATO/EPS composite is doped with 0.5 wt. % to 2 wt. % of the rutile TiO₂@ATO based on a mass of a styrene monomer.

In some embodiments of the present disclosure, the rutile TiO₂@ATO is doped at 1 wt. % to 1.5 wt. %.

In some embodiments of the present disclosure, a tin element has a mass percentage of 20% and an antimony element has a mass of 3% to 8%, and preferably 5% in the rutile TiO₂@ ATO.

The present disclosure further provides a method for preparing the antistatic and flame-retardant rutile TiO₂@ATO/EPS composite as mentioned above, including the following steps:
mixing the rutile TiO₂@ATO, a silane coupling agent, and an organic solvent, and conducting modification to obtain a modified rutile TiO₂@ATO;
mixing the modified rutile TiO₂@ATO, the styrene monomer, an initiator, a dispersant, an auxiliary dispersant, and water, and subjecting a resulting mixture to polymerization to obtain rutile TiO₂@ATO-doped polystyrene particles; and
subjecting the rutile TiO₂@ATO-doped polystyrene particles to foaming to obtain the antistatic and flame-retardant rutile TiO₂@ATO/EPS composite.

In the present disclosure, unless otherwise specified, all raw materials used are commercially available products conventional in the art.

In the present disclosure, the rutile TiO₂@ATO, a silane coupling agent, and an organic solvent are mixed, and then subjected to modification to obtain a modified rutile TiO₂@ATO.

In some embodiments of the present disclosure, the rutile TiO₂@ATO is prepared by a process including:
mixing one-dimensional rutile TiO₂, tin tetrachloride pentahydrate, and antimony trichloride, and subjecting a resulting mixture to chemical coprecipitation to obtain a mixture of rutile TiO₂, tin hydroxide, and antimony hydroxide; and
subjecting the mixture of the rutile TiO₂, the tin hydroxide, and the antimony hydroxide to drying and calcination in sequence to obtain the rutile TiO₂@ATO.

In the present disclosure, there is no special limitation on a source of the one-dimensional rutile TiO₂, and the one-dimensional rutile TiO₂ can be prepared by using sources well known to those skilled in the art or conventional preparation methods. In a specific embodiment, the one-dimensional rutile TiO₂ is prepared by high-temperature calcination using metatitanic acid as a raw material.

In some embodiments of the present disclosure, the chemical coprecipitation is conducted at 60° C.

In some embodiments of the present disclosure, the calcination is conducted at 600° C. for 3 h in a muffle furnace.

In some embodiments of the present disclosure, a mass ratio of the rutile TiO₂@ATO to the silane coupling agent is in a range of 1:(0.05-0.15), and preferably 1:0.1.

In some embodiments of the present disclosure, the silane coupling agent is one selected from the group consisting of KH570 (γ-methacryloxy propyl trimethoxyl silane, CAS: 2530-85-0) and KH550 (γ-aminopropyl tricthoxysilane, CAS: 919-30-2).

In some embodiments of the present disclosure, the organic solvent is anhydrous ethanol.

In some embodiments of the present disclosure, a dosage ratio of the rutile TiO₂@ ATO to the anhydrous ethanol is 1 g: 20 mL.

In some embodiments of the present disclosure, the modification is conducted at 60° C. for 6 h. During the modification, a hydrolysis functional group of the silane coupling agent reacts with a hydroxyl group on a surface of the rutile TiO₂@ATO to impart oleophilicity and hydrophobicity to the material and improve its dispersibility in polystyrene.

In some embodiments of the present disclosure, drying is conducted after the modification is completed.

In some embodiments of the present disclosure, the drying is conducted by oven drying, and the oven drying is conducted at 100° C. for 12 h.

In a specific embodiment of the present disclosure, the rutile TiO₂@ATO and the anhydrous ethanol are placed in a beaker, and then the silane coupling agent is added thereto; the beaker is stirred at 60° C. and 200 rpm in a constant-temperature water bath for 6 h; and then a resulting sample is centrifugally washed with anhydrous ethanol and then dried in an oven at 100° C. for 12 h to obtain the modified rutile TiO₂@ATO.

In the present disclosure, the modified rutile TiO₂@ATO, the styrene monomer, an initiator, a dispersant, an auxiliary dispersant, and water are mixed, and a resulting mixture is subjected to polymerization to obtain rutile TiO₂@ATO-doped polystyrene particles.

In some embodiments of the present disclosure, a mass ratio of the modified rutile TiO₂@ATO, the styrene monomer, the initiator, the dispersant, and the auxiliary dispersant is in a range of (0.1-0.4):20:0.5:(0.14-0.35):(0.303-0.7575), and preferably 0.1:20:0.5:0.14:0.303, 0.2:20:0.5:0.21:0.4545, 0.3:20:0.5:0.28:0.606, or 0.4:20:0.5:0.35:0.7575.

In some embodiments of the present disclosure, the initiator includes BPO; the dispersant includes hydroxyapatite; and the auxiliary dispersant includes SDBS and anhydrous sodium carbonate, with a mass ratio of the SDBS to the anhydrous sodium carbonate is in a range of (0.01-0.025):(1-2.5), and preferably 0.1:1. The BPO serves as an initiator, which decomposes at 90° C. to initiate styrene polymerization; the hydroxyapatite, SDBS, and anhydrous sodium carbonate are added to ensure that the styrene and water system forms uniform oil-in-water particles under stirring, and then forms polystyrene microspheres.

In some embodiments of the present disclosure, a ratio of a mass of the modified rutile TiO₂@ATO to a volume of the water is in a range of (0.1-0.4) g: 60 mL, and preferably (0.2-0.3) g: 60 mL.

In some embodiments of the present disclosure, the polymerization includes: maintaining at 50° C. for 1 h, and then gradient heating at a rate of 10° C. to 15° C. per 30 min to 90° C. to 92° C. and maintaining for 2.5 h.

In some embodiments of the present disclosure, the polymerization is conducted in a constant-temperature water bath with stirring, and the stirring is conducted at 360 rpm.

In some embodiments of the present disclosure, the styrene monomer, the initiator, the dispersant, the auxiliary dispersant, and the water are added into the modified rutile TiO₂@ATO simultaneously.

In some embodiments of the present disclosure, after the polymerization is completed, obtained solid particles harden and sink, the solid particles are naturally cooled to room temperature, washed repeatedly with deionized water three times, and then dried in an oven at 60° C. for 12 h to obtain the rutile TiO₂@ATO-doped polystyrene particles.

In some embodiments of the present disclosure, the rutile TiO₂@ATO-doped polystyrene particles each have a particle size of 1.6 mm to 2 mm.

In the present disclosure, the rutile TiO₂@ATO-doped polystyrene particles are subjected to foaming to obtain the antistatic and flame-retardant rutile TiO₂@ATO/EPS composite.

In some embodiments of the present disclosure, the foaming is conducted at a temperature of 90° C. to 110° C. for 6 h to 12 h.

In some embodiments of the present disclosure, the foaming includes: immersing the rutile TiO₂@ATO-doped polystyrene particles in deionized water for 8 h to 10 h; placing a resulting immersed particle material (10 g) into a reactor, adding deionized water (100 mL) into the reactor, closing the reactor, and introducing CO₂ into the reactor at room temperature; when a pressure in the reactor reaches 4.5 MPa, stopping introducing CO₂ and heating the reactor to 90° C. to 110° C. at a rate of 10° C. to 15° C. per 10 min and maintaining for 6 h; quickly discharging the CO₂ in the reactor within 10 s to 20 s, opening the reactor, and naturally cooling to room temperature to obtain the antistatic and flame-retardant rutile TiO₂@ATO/EPS composite.

The present disclosure further provides use of the antistatic and flame-retardant rutile TiO₂@ATO/EPS composite as mentioned above or the antistatic and flame-retardant rutile TiO₂@ATO/EPS composite prepared by the method as mentioned above in an antistatic and flame-retardant thermal insulation material and a building thermal insulation material.

There is no special limitation on a specific manner for the use, and manners well known to those skilled in the art may be used.

In some embodiments of the present disclosure, the use is for instrument and electrical protection or chemical equipment.

The technical solutions of the present disclosure will be clearly and completely described below with reference to the examples of the present disclosure. Apparently, the described embodiments are merely some rather than all of the embodiments of the present disclosure. All other examples obtained by a person of ordinary skill in the art based on the examples of the present disclosure without inventive labour shall fall within the scope of the present disclosure.

### Example 1

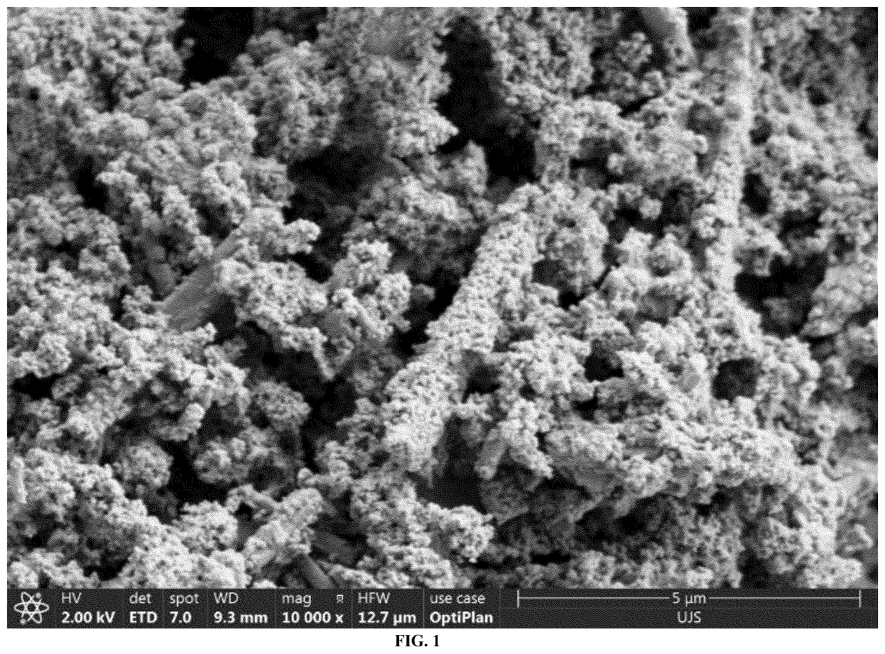

One-dimensional rutile TiO₂ was synthesized by high-temperature calcination using metatitanic acid as a raw material. The one-dimensional rutile TiO₂, tin tetrachloride pentahydrate, and antimony trichloride were synthesized into a mixture of rutile TiO₂, tin hydroxide, and antimony hydroxide by chemical coprecipitation in a 60° C. water bath. The mixture is suction-filtered, washed, and dried in sequence, and then calcined in a muffle furnace at 600° C. for 3 h to obtain one-dimensional rutile TiO₂@ATO, where the rutile TiO₂@ATO has a tin element with a mass percentage of 20% and an antimony element with a mass percentage of 5%. A SEM image of the rutile TiO₂@ATO is shown in FIG. 1.

3 g of the rutile TiO₂@ATO and 60 mL of anhydrous ethanol were put into a beaker, and 0.15 g of a silane coupling agent KH570 was added thereto. The beaker was placed in a constant-temperature water bath and stirred at 60° C. and 200 rpm for 6 h, then a resulting sample was centrifugally washed with anhydrous ethanol and then dried in an oven at 100° C. for 12 h to obtain a modified rutile TiO₂@ATO. 0.1 g of the modified rutile TiO₂@ATO was added to a three-necked flask, and 20 g of a styrene monomer, 60 mL of deionized water, 0.5 g of BPO, 0.003 g of SDBS, 0.3 g of anhydrous sodium carbonate, and 0.14 g of hydroxyapatite were added thereto. The three-necked flask was placed in a constant-temperature water bath, stirred at 360 rpm and 50° C. for 1 h, and gradient heated to 90° C. at 10° C. per 30 min and then maintained for 2.5 h. When all polystyrene beads were hardened and sank, the heating was stopped, and the beads were cooled naturally to room temperature, washed repeatedly with deionized water three times, and dried in an oven at 60° C. for 12 h to obtain rutile TiO₂@ATO-doped polystyrene particles with a doping amount of 0.5 wt. % (calculated based on a mass of the styrene monomer). The polystyrene particles each have a particle size of 1.6 mm to 2 mm after measurement.

10 g of the rutile TiO₂@ATO-doped polystyrene particles was immersed in deionized water for 8 h; a resulting immersed particle material was placed into a reactor, 100 mL of deionized water was added into the reactor, the reactor was closed, and CO₂ was introduced into the reactor at room temperature; when a pressure in the reactor reached 4.5 MPa, introducing CO₂ was stopped and the reactor was heated to 90° C. at 10° C. per 10 min and maintained for 6 h. After maintaining for 6 h, CO₂ in the reactor was quickly discharged within 10 s, the reactor was opened, and naturally cooled to room temperature to obtain a rutile TiO₂@ATO/EPS composite with a doping amount of the rutile TiO₂@ATO of 0.5 wt. %.

### Example 2

This example was the same as Example 1, except that the dosage of silane coupling agent KH570 was changed to 0.3 g.

### Example 3

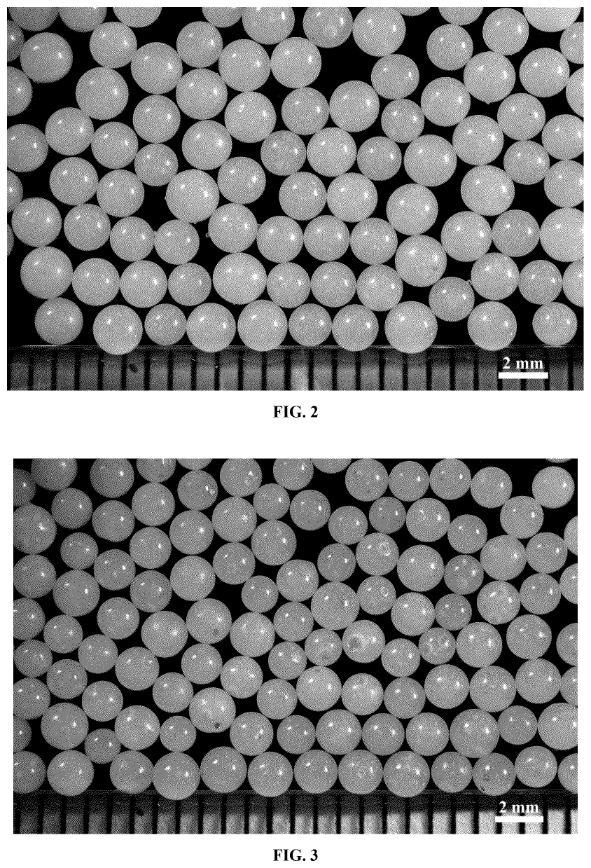

This example was the same as Example 1, except that the dosage of silane coupling agent KH570 was changed to 0.45 g. FIG. 2 shows a physical picture of the rutile TiO₂@ATO/EPS composite with a doping amount of the rutile TiO₂@ATO of 0.5 wt. %.

### Example 4

This example was the same as Example 3, except that a mass percentage of antimony element in rutile TiO₂@ATO was changed to 3%.

### Example 5

This example was the same as Example 3, except that a mass percentage of antimony element in rutile TiO₂@ATO was changed to 8%.

### Example 6

3 g of the rutile TiO₂@ATO prepared in Example 1 and 60 mL of anhydrous ethanol were placed in a beaker, and 0.45 g of a silane coupling agent KH570 was added thereto. The beaker was placed in a constant-temperature water bath and stirred at 60° C. and 200 rpm for 6 h, then a resulting sample was centrifugally washed with anhydrous ethanol and then dried in an oven at 100° C. for 12 h to obtain a modified rutile TiO₂@ATO. 0.2 g of the modified rutile TiO₂@ATO was added to a three-necked flask, and 20 g of a styrene monomer, 60 mL of deionized water, 0.5 g of BPO, 0.0045 g of SDBS, 0.45 g of anhydrous sodium carbonate, and 0.21 g of hydroxyapatite were added thereto. The three-necked flask was placed in a constant-temperature water bath, stirred at 360 rpm and 50° C. for 1 h, and gradient heated to 90° C. at 10° C. per 30 min and then maintained for 2.5 h. When all polystyrene beads were hardened and sank, the heating was stopped, and the beads were cooled naturally to room temperature, washed repeatedly with deionized water three times, and dried in an oven at 60° C. for 12 h to obtain rutile TiO₂@ATO-doped polystyrene particles with a doping amount of 1 wt. % (calculated based on a mass of the styrene monomer). The polystyrene particles each have a particle size of 1.6 mm to 2 mm after measurement.

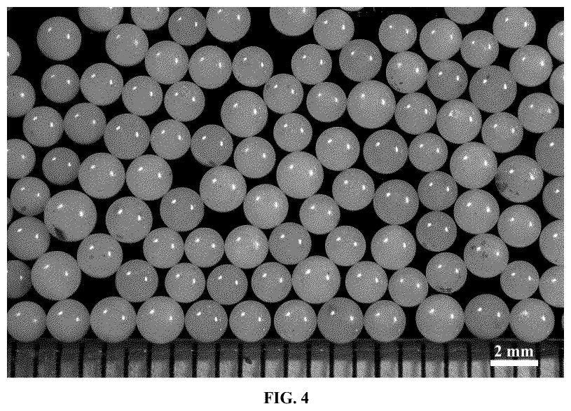

10 g of the rutile TiO₂@ATO-doped polystyrene particles was immersed in deionized water for 8 h; a resulting immersed particle material was placed into a reactor, 100 mL of deionized water was added into the reactor, the reactor was closed, and CO₂ was introduced into the reactor at room temperature; when a pressure in the reactor reached 4.5 MPa, introducing CO₂ was stopped and the reactor was heated to 90° C. at 10° C. per 10 min and maintained for 6 h. After maintaining for 6 h, CO₂ in the reactor was quickly discharged within 10 s, the reactor was opened, and naturally cooled to room temperature to obtain a rutile TiO₂@ATO/EPS composite with a doping amount of the rutile TiO₂@ATO of 1 wt. %. FIG. 3 shows a physical picture of the rutile TiO₂@ATO/EPS composite with a doping amount of the rutile TiO₂@ATO of 1 wt. %.

### Example 7

This example was the same as Example 6, except that the modified rutile TiO₂@ATO powder was 0.3 g, SDBS was 0.006 g, anhydrous sodium carbonate was 0.6 g, and hydroxyapatite was 0.28 g.

### Example 8

This example was the same as Example 6, except that the modified rutile TiO₂@ATO powder was 0.4 g, SDBS was 0.0075 g, anhydrous sodium carbonate was 0.75 g, and hydroxyapatite was 0.35 g. FIG. 4 shows a physical picture of the rutile TiO₂@ATO/EPS composite with a doping amount of the rutile TiO₂@ATO of 2 wt. % (calculated based on a mass of the styrene monomer).

### Example 9

This example was the same as Example 8, except that the foaming was conducted at 100° C.

### Example 10

This example was the same as Example 8, except that the foaming was conducted at 110° C.

The performances of the rutile TiO₂@ATO/EPS composites obtained in Examples 1 to 10 were investigated, respectively, and the specific process was as follows:

### 1. Antistatic Performance

The prepared rutile TiO₂@ATO/EPS composite was cut into square sheets with a side length of 10 mm and a thickness of 0.5 mm using a blade, and the volume resistivity of the sheets was measured using an ST2648 ultra-high resistance micro-current tester.

### 2. Flame Retardancy

The limiting oxygen index was tested according to ASTM D2863 method.

The limiting oxygen index in a combustion process of the rutile TiO₂@ATO/EPS composite was obtained by testing with an oxygen index tester.

The pure EPS was measured to have a surface resistance of 9.8×10¹⁰ kΩ and a limiting oxygen index of 18%.

Table 1 shows the preparation parameters and performance test results of Examples 1 to 10.

TABLE 1
Preparation parameters and performance test results of Examples 1 to 10

| Example | 1 | 2 | 3 | 4 | 5 | 6 | 7 | 8 | 9 | 10 |
|---|---|---|---|---|---|---|---|---|---|---|
| KH570/g | 0.15 | 0.3 | 0.45 | 0.45 | 0.45 | 0.45 | 0.45 | 0.45 | 0.45 | 0.45 |
| Mass percentage | 5 | 5 | 5 | 3 | 8 | 5 | 5 | 5 | 5 | 5 |
| of antimony | | | | | | | | | | |
| element in rutile | | | | | | | | | | |
| TiO₂@ATO/% | | | | | | | | | | |
| Modified rutile | 0.1 | 0.1 | 0.1 | 0.1 | 0.1 | 0.2 | 0.3 | 0.4 | 0.4 | 0.4 |
| TiO₂@ATO | | | | | | | | | | |
| powder/g | | | | | | | | | | |
| SDBS/g | 0.003 | 0.003 | 0.003 | 0.003 | 0.003 | 0.0045 | 0.006 | 0.0075 | 0.0075 | 0.0075 |
| Anhydrous sodium | 0.3 | 0.3 | 0.3 | 0.3 | 0.3 | 0.45 | 0.6 | 0.75 | 0.75 | 0.75 |
| carbonate/g | | | | | | | | | | |
| Hydroxyapatite/g | 0.14 | 0.14 | 0.14 | 0.14 | 0.14 | 0.21 | 0.28 | 0.35 | 0.35 | 0.35 |
| Foaming | 90 | 90 | 90 | 90 | 90 | 90 | 90 | 90 | 100 | 110 |
| temperature/° C. | | | | | | | | | | |
| Surface | 3.3 × | 9.7 × | 8.8 × | 2.5 × | 8.5 × | 3.4 × | 1.2 × | 5.1 × | 5.0 × | 5.2 × |
| resistance/kΩ | 10⁸ | 10⁶ | 10⁵ | 10⁶ | 10⁵ | 10⁵ | 10⁵ | 10⁴ | 10⁴ | 10⁴ |
| Limiting oxygen | 25.5 | 27.1 | 28.4 | 28.0 | 28.2 | 30.3 | 32.4 | 34.1 | 35.0 | 35.7 |
| index/% | | | | | | | | | | |

As shown in Table 1, surface modification of rutile TiO₂@ATO using silane coupling agent KH550 could significantly improve the doping effect. When the doping amount reaches 2 wt. % of the mass of styrene monomer, the surface resistance of the rutile TiO₂@ATO/EPS composite is reduced to 5.0×10⁴ kΩ, meeting for the antistatic performance requirements. Moreover, as the foaming temperature gradually increased, the flame-retardant properties of the composite gradually increased. At a foaming temperature of 110° C., the limiting oxygen index reaches 35.7%, indicating that the flame-retardant properties have been significantly improved compared with pure EPS.

The above described are merely preferred embodiments of the present disclosure rather than limitations to the present disclosure in any form. It should be noted that those of ordinary skill in the art may further make several improvements and modifications without departing from the principle of the present disclosure, but such improvements and modifications should be deemed as falling within the scope of the present disclosure.

What is claimed is:

1. An antistatic and flame-retardant rutile titanium dioxide (TiO₂)-loaded antimony tin oxide (ATO)/expanded polystyrene (EPS) composite, comprising EPS and rutile TiO₂-loaded ATO (TiO₂@ATO) doped in the EPS;
wherein the antistatic and flame-retardant rutile TiO₂@ATO/EPS composite is doped with 0.5 wt. % to 2 wt. % of the rutile TiO₂@ATO based on a mass of a styrene monomer.

2. The antistatic and flame-retardant rutile TiO₂@ATO/EPS composite according to claim 1, wherein the rutile TiO₂@ATO is doped at 1 wt. % to 1.5 wt. %.

3. The antistatic and flame-retardant rutile TiO₂@ATO/EPS composite according to claim 1, wherein a tin element has a mass percentage of 20% and an antimony element has a mass percentage of 3% to 8% in the rutile TiO₂@ATO.

4. The antistatic and flame-retardant rutile TiO₂@ATO/EPS composite according to claim 3, wherein the antimony element has a mass percentage of 5% in the rutile TiO₂@ATO.

5. A method for preparing the antistatic and flame-retardant rutile TiO₂@ATO/EPS composite according to claim 1, comprising the following steps:
mixing the rutile TiO₂@ATO, a silane coupling agent, and an organic solvent, and conducting modification to obtain a modified rutile TiO₂@ATO;
mixing the modified rutile TiO₂@ATO, the styrene monomer, an initiator, a dispersant, an auxiliary dispersant, and water, and subjecting a resulting mixture to polymerization to obtain rutile TiO₂@ATO-doped polystyrene particles; and
subjecting the rutile TiO₂@ATO-doped polystyrene particles to foaming to obtain the antistatic and flame-retardant rutile TiO₂@ATO/EPS composite.

6. The method according to claim 5, wherein a mass ratio of the rutile TiO₂@ATO to the silane coupling agent is in a range of 1:(0.05-0.15).

7. The method according to claim 5, wherein a mass ratio of the modified rutile TiO₂@ATO, the styrene monomer, the initiator, the dispersant, and the auxiliary dispersant is in a range of (0.1-0.4):20:0.5:(0.14-0.35):(0.303-0.7575).

8. The method according to claim 7, wherein the initiator comprises dibenzoyl peroxide (BPO);
the dispersant comprises hydroxyapatite; and
the auxiliary dispersant comprises sodium dodecylbenzene sulfonate (SDBS) and anhydrous sodium carbonate, with a mass ratio of the SDBS to the anhydrous sodium carbonate being in a range of (0.01-0.025):(1-2.5).

9. The method according to claim 5, wherein the foaming is conducted at a temperature of 90° C. to 110° C. for 6 h to 12 h.

10. The antistatic and flame-retardant rutile TiO₂@ATO/EPS composite according to claim 2, wherein a tin element has a mass percentage of 20% and an antimony element has a mass percentage of 3% to 8% in the rutile TiO₂@ATO.

11. The method according to claim 5, wherein the rutile TiO₂@ATO is doped at 1 wt. % to 1.5 wt. %.

12. The method according to claim 5, wherein a tin element has a mass percentage of 20% and an antimony element has a mass percentage of 3% to 8% in the rutile TiO₂@ATO.

13. The method according to claim 12, wherein the antimony element has a mass percentage of 5% in the rutile TiO₂@ATO.
